(19) United States
(12) Patent Application Publication
(10) Pub. No.: US 2005/0047437 A1
(43) Pub. Date: Mar. 3, 2005

(54) Internet protocol terminal and method of providing short message service in busy state

(76) Inventor: Seong-Kwan Cho, Suwon-si (KR)

Correspondence Address: Robert E. Bushnell, Suite 300, 1522 K Street, N.W., Washington, DC, 20005-1202, US

(21) Appl. No.: 10/921,833

(22) Filed: Aug. 20, 2004

(30) Foreign Application Priority Data
Aug. 20, 2003 (KR) 2003-58875

(51) Int. Cl. H04L 12/56

(52) U.S. Cl. 370/466; 455/466

(57) ABSTRACT

A Short Message Service (SMS) of an Internet Protocol (IP) terminal to which a call is set up via a network according to a Voice over Internet Protocol (VoIP) effects voice communication. While the call is set up via the network according to VoIP to effect voice communication, the IP terminal either exchanges character information with a correspondent IP terminal to which the call is set up, or, when a call set-up request has been received from a third IP terminal, exchanges character information with the third IP terminal sending the call set-up request while continuing to maintain the voice communication.

### CLAIM OF PRIORITY

This application makes reference to, incorporates the same herein, and claims all benefits accruing under 35 U.S.C. §119 from an application for INTERNET PROTOCOL TERMINAL AND METHOD FOR PROVIDING SHORT MESSAGE SERVICE IN BUSY STATE earlier filed in the Korean Intellectual Property Office on 25 Aug. 2003 and there duly assigned Serial No. 2003-58875.

### BACKGROUND OF THE INVENTION

1. Field of the Invention

The present invention relates to an Internet Protocol (IP) terminal and method of providing a Short Message Service (SMS) and, more particularly, to an IP terminal and method of providing an SMS in a busy state, adapted to allow the IP terminal based on Voice over Internet Protocol (VoIP) to perform a chatting service with either a correspondent IP terminal or a third IP terminal, either of which is in a busy state.

2. Description of the Related Art

VoIP designates IP telephony for a set of facilities for transmitting voice information using the IP. In general, this means sending the voice information in digital form in discrete packets rather than over traditional circuit-based protocols as in a Public Switched Telephone Network (PSTN). A major advantage of the VoIP or Internet telephony is that, by realizing an integrated telephone service by application of an existing IP network as it stands, telephone users can get a long-distance call service as well as an international call service under the environment of Internet or Intranet at the cost of a local call.

As a protocol for realizing the VoIP, there are defined H.323, SIP (Session Initiation Protocol), MGCP (Media Gateway Control Protocol), and so forth. Presently, SIP, a simple text based application layer control protocol, is widely commercialized.

SIP is for setting up and controlling a session between terminals or between users, and is the simple text based application layer control protocol for creating, modifying and terminating sessions with one or more participants. Such sessions include a remote conference, telephony, presence, Short Message Service (SMS), and so forth using the Internet.

SIP was developed at the Multiparty Multimedia Session Control (MMUSIC) working group of the Internet Engineering Task Force (IETF) and was published on March, 1993, and its standard proposal is generally described in RFC (Request for Comments) 2543.

The following patents each discloses features in common with the present invention but do not teach or suggest the inventive features specifically recited in the present application: U.S. patent application Ser. No. 2004/0057561 to Gilbert, entitled SYSTEM AND METHOD FOR MESSAGE DELIVER Y TO A BUSY CALLED PARTY, published on Mar. 25, 2004; U.S. patent application Ser. No. 2003/0046328 to Goo et al., entitled METHOD FOR TRANSMITTING SHORT MESSAGE USING INTERNET PHONES AND SYSTEM THEREFOR, published on Mar. 6, 2003; and U.S. patent application Ser. No. 2002/0181672 to Cannell et al., entitled METHOD AND SYSTEM FOR SENDING A DATA RESPONSE FROM A CALLED PHONE TO A CALLING PHONE, published on Dec. 5, 2002.

### SUMMARY OF THE INVENTION

It is an object of the present invention to provide an IP terminal and method of providing a Short Message Service in a busy state, designed to provide the Short Message Service to the IP terminal to which a call is set up to perform voice communication according to an SIP, and to allow the IP terminal in a busy state to provide the Short Message Service to a third IP terminal.

To achieve the above objects, according to one aspect of the present invention, an Internet Protocol terminal is provided comprising: a memory adapted to store address information of another Internet Protocol terminal to which a call is set up and character information intended to be transmitted to the another Internet Protocol terminal; and a message processor adapted to generate and display both an address information field of the another Internet Protocol terminal stored in the memory and a character information input field upon the call being set up to the another Internet Protocol terminal and upon a Short Message Service request signal being received from a user, and the message processor adapted to store the inputted character information in the memory and to transmit the stored character information to the another Internet Protocol terminal upon the character information intended for transmission being inputted via the character information input field.

Preferably, the message processor comprises: a character information processor adapted to generate and output the character information input field, and to receive and store the character information from the user inputted via the character information input field; and a transmitter adapted to determine whether or not a character information transmission request signal has been received from the user, and if so, to transmit the character information to the another Internet Protocol terminal, the character information being received from the character information processor and stored and the character information processor being adapted to generate and display the character information input field to correspond to a display field outputting the address information of the another Internet Protocol terminal.

Further, according to another aspect of the present invention, an Internet Protocol terminal is provided comprising: a memory adapted to store address information of respective Internet Protocol terminals and character information intended for transmission; and a message processor adapted to store address information of a third Internet Protocol terminal in the memory upon a call being set up between a first Internet Protocol terminal and a second Internet Protocol terminal in a Voice over Internet Protocol mode and upon a call set-up request signal being received from the third Internet Protocol terminal; and the message processor being adapted to generate and display both input fields for the stored address information of the respective Internet Protocol terminals and character information input fields and to store the character information inputted via the character information input fields upon a Short Message Service request signal being received from a user; and the message processor being adapted to transmit the inputted character information to the third Internet Protocol terminal upon a character information transmission request signal being received from the user upon the call being set up between the first Internet Protocol terminal and the second Internet Protocol terminal.

Preferably, the message processor is adapted to generate and display the character information input fields and the address information input fields upon the Short Message Service request signal being received from the user and upon the call being set up to the second Internet Protocol terminal; and the message processor is adapted to transmit the character information inputted via the character information input fields to the third Internet Protocol terminal inputted via the address information input fields from the user.

Furthermore, the message processor preferably comprises: a voice communication processor adapted to transmit a busy message to the third Internet Protocol terminal and to store the address information of the third Internet Protocol terminal in the memory upon the call set-up request signal being received from the third Internet Protocol terminal; and a character information processor adapted to generate the character information input fields and to add the character information indicating that the call set-up request signal has been received from the third Internet Protocol terminal in a busy state in response to the generated character information input fields and to display the added character information. Still furthermore, the character information processor is adapted to generate and display the character information input fields to correspond to the address information of the first, second and third Internet Protocol terminals and to automatically select the third Internet Protocol terminal as the Internet Protocol terminal for transmitting the character information upon the Short Message Service request signal being received from the user and the Internet Protocol terminal for transmitting the character information is adapted to automatically select the third Internet Protocol terminal transmitting the call set-up request signal upon the call being set up and upon the Short Message Service request signal being received from the user and to select the Internet Protocol terminal selected by the user upon an Internet Protocol terminal select signal being received from the user.

Further, according to another aspect of the present invention, a method is provided comprising: setting up a call to another Internet Protocol terminal through a network according to a call set-up method of the Voice over Internet Protocol and to store address information of the another Internet Protocol terminal to which the call is being set up; generating and outputting both a field for the stored address information and a character information input field upon a Short Message Service request signal being received from a user; receiving and storing character information intended for transmission from the user via the character information input field and determining whether or not a character information transmission signal has been received; and transmitting the character information inputted via the character information input field to the another Internet Protocol terminal upon a determination that the character information transmission signal has received.

Still furthermore, according to another aspect of the present invention, a method is provided comprising: setting up a call between first and second Internet Protocol terminals via a network according to a call set-up method of the Voice over Internet Protocol and to store address information of the second Internet Protocol terminal to which the call is being set up; transmitting a busy message to a third Internet Protocol terminal upon the call being set up to the second Internet Protocol terminal and upon a call set-up request signal being received from the third Internet Protocol terminal; storing address information of the third Internet Protocol terminal and generating and displaying both a field for the address information of the third Internet Protocol terminal and a character information input field; receiving and storing character information intended for transmission from the user via the character information input field and determining whether or not a character information transmission signal has been received; and transmitting the character information inputted via the character information input field to the third Internet Protocol terminal upon the call being set up between the first and second Internet Protocol terminals and upon a determination that the character information transmission signal has been received.

The method preferably further comprises: automatically selecting the address information of the third Internet Protocol terminal transmitting the call set-up request signal upon the call being set up as address information of the Internet Protocol terminal for transmitting the character information; and selecting address information of the selected Internet Protocol terminal as the address information of the Internet Protocol terminal for transmitting the character information upon an Internet Protocol terminal select signal being received from the user.

Preferably, the character information input field has added information and is used to generate character information from which the user can determine that the call set-up request signal has been received in a busy state.

Still furthermore, according to another aspect of the present invention, a method is provided comprising: setting up a call to an arbitrary terminal through a network according to a call set-up method of the Voice over Internet Protocol and to store address information of the terminal to which the call is being set up; displaying a display signal corresponding to the stored address information of the terminal and a request signal requesting that character information intended for transmission be inputted via the terminal upon a Short Message Service request signal being received; storing the inputted character information and determining whether or not a character information transmission signal has been received upon the character information intended for transmission being inputted from the terminal in response to the request signal; and transmitting the stored character information to the terminal to which the call is being set up upon a determination that the character information transmission signal has been received.

Still furthermore, according to another aspect of the present invention, a method is provided comprising: storing address information of a second terminal to which a call is being set up in a first terminal upon a call being set up between the first and second terminals via a network according to a call set-up method of the Voice over Internet Protocol; transmitting a message to a third terminal indicating that the call is being set up upon the call being set up to the second terminal and upon a call set-up request signal being received from the third terminal; displaying a display signal of address information of the third terminal and a request signal requesting that character information intended for transmission is being inputted via one of the first and second terminals upon a Short Message Service request signal being received; storing the inputted character information and determining whether or not a character information transmission signal has been received upon the character information being inputted from one of the first and second terminals in response to the request signal; and transmitting the stored character information to the third terminal upon the call being set up between the first and second terminals upon a determination that the character information transmission signal has been received.

Preferably, the method further comprises: automatically selecting the address information of the third terminal transmitting the call set-up request signal upon the call being set up as the address information of the terminal for transmitting the character information received in response to the request signal upon the Short Message Service request signal being received; and selecting the received address information upon arbitrary address information being received while the character information is being inputted.

### BRIEF DESCRIPTION OF THE DRAWINGS

A more complete appreciation of the invention, and many of the attendant advantages thereof, will be readily apparent as the same becomes better understood by reference to following detailed description when considered in conjunction with the accompanying drawings in which like reference symbols indicate the same or similar component, wherein:

FIG. 1 is a flow diagram of messages for setting up a call between a transmission IP terminal and a reception IP terminal in an SIP scheme;

FIG. 2 is a structure of an ‘INVITE’ message in an ‘INVITE’ method in an SIP scheme;

FIG. 3 is a flow diagram of messages for transmitting short messages between a transmission IP terminal and a reception IP terminal in an SIP scheme;

FIG. 4 is a structure of a message of ‘MESSAGE’ in a ‘MESSAGE’ method in an SIP scheme;

FIG. 5 is an internal block construction of an IP terminal employed with an embodiment of the present invention;

FIG. 6 is a flowchart explaining a method of transmitting character information to a correspondent IP terminal in a busy state in accordance with an embodiment of the present invention; and

FIG. 7 is a flowchart explaining a method of transmitting character information to a third IP terminal in a busy state in accordance with another embodiment of the present invention.

### DETAILED DESCRIPTION OF THE INVENTION

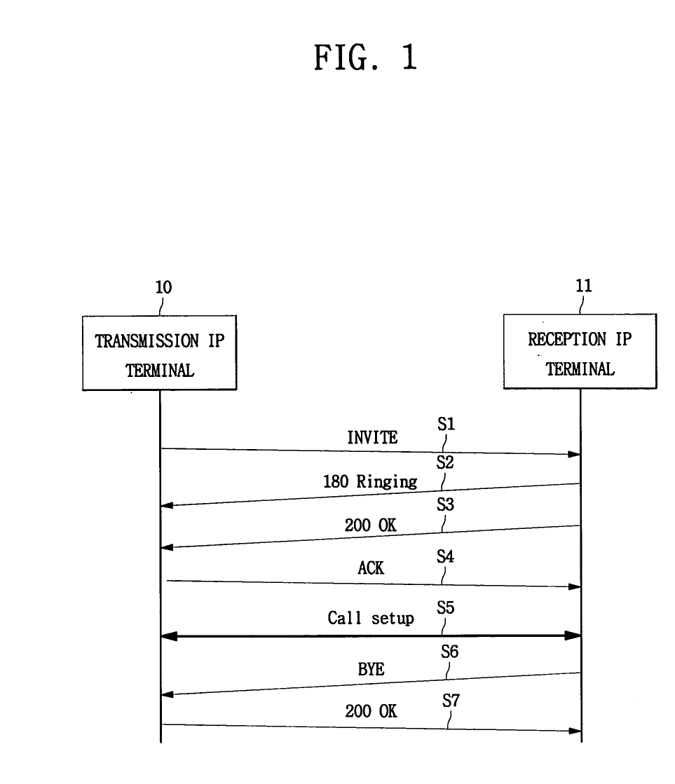

FIG. 1 is a flow diagram of messages for setting up a call between a transmission IP terminal and a reception IP terminal in an SIP scheme.

Referring to FIG. 1, a transmission IP terminal 10 transmits a call connection request signal to a reception IP terminal 11 in order to perform voice communication with the reception IP terminal 11.

The reception IP terminal 11 receives the call connection request signal transmitted from the transmission IP terminal 10, and then transmits a return signal to the received call connection request signal to the transmission IP terminal 10, thereby performing the voice communication based on call connection with the transmission IP terminal 10.

A more detailed description follows with regard to a procedure for setting up a call between the transmission/reception IP terminals 10 and 11 with reference to FIG. 1.

The transmission IP terminal 10 transmits an ‘INVITE’ message to the reception IP terminal 11 (S1).

The reception IP terminal 11, which has received the ‘INVITE’ message, transmits a ‘180 Ringing’ signal to the transmission IP terminal 10 in response to the receipt of the “INVITE” message (S2).

The reception IP terminal 11, also, transmits a ‘200 OK’ message indicating that the reception IP terminal 11 accepts an invitation to a session in response to the ‘INVITE’ message (S3).

The transmission IP terminal 10 transmits an ‘ACK’ message as a final acknowledgment message to the ‘200 OK’ message to the reception IP terminal 11 (S4). Thus, the call is established between the transmission IP terminal 10 and the reception IP terminal 11 to perform voice communication (S5).

While this call connection allows the voice communication to be performed between the transmission IP terminal 10 and the reception IP terminal 11, when the reception IP terminal 11 wants to terminate the voice communication, the reception IP terminal 11 transmits a ‘BYE’ message for terminating the voice communication to the transmission IP terminal 10 (S6).

The transmission IP terminal 10 transmits the ‘200 OK’ message for acknowledging the ‘BYE’ message to the reception IP terminal 11 upon receiving the ‘BYE’ message transmitted from the reception IP terminal 11. Thus, the call between the transmission and reception IP terminals 10 and 11 is disconnected (S7).

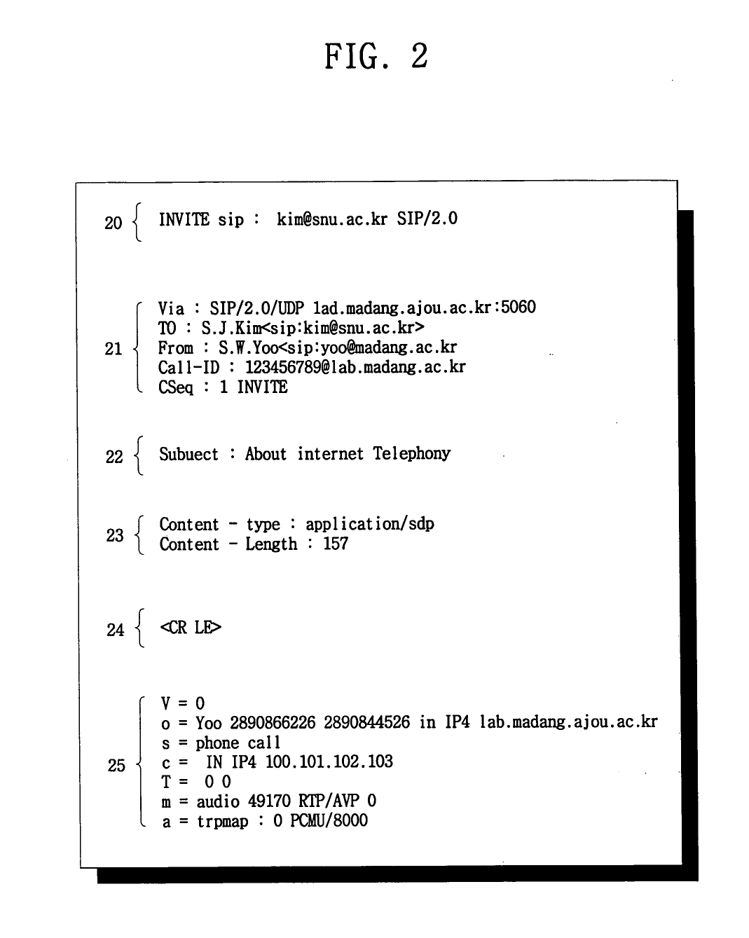

FIG. 2 is a structure of an ‘INVITE’ message in an ‘INVITE’ method of an SIP scheme.

Taking an ‘INVITE’ message as one example, the ‘INVITE’ message consists of a start line 20, a general header 21, a request header 22, an entity header 23, an empty line 24, and message information 25.

The start line 20 functions to indicate a start of the ‘INVITE’ message.

The general header 21 includes a request message and a response message, and represents a selected path for ‘Via,’ a respondent of request for ‘TO,’ an initiator of request for ‘From,’ invitation to a specific call or registration of a specific client for ‘Call-ID,’ and a priority of a corresponding message for ‘CSeq.’

The request header 22 identifies the application of the corresponding message, and the entity header 23 refers to a type and a length of the message information.

The empty line 24 indicates remaining capacities after the corresponding information is expressed among capacities of the ‘INVITE’ message in the SIP scheme, and the message information 25 provides information required for voice communication.

One or more participants can create, modify and terminate together sessions on the basis of the Internet using this simple text based message, so that it is possible to provide a remote conference, telephony, a presence, a short message service, and so on.

Further, the IP terminals for setting up a call to perform the voice communication according to the SIP are capable of receiving the SMS through a ‘MESSAGE’ method of the SIP.

FIG. 3 is a flow diagram of messages for transmitting short messages between a transmission IP terminal 10 and a reception IP terminal 11 in an SIP scheme.

Referring to FIG. 3, the transmission IP terminal 10 receives character information intended for transmission from a user, and transmits a ‘MESSAGE’ containing the received character information to the reception IP terminal 11 (S8).

The reception IP terminal 11 extracts the character information contained in the ‘MESSAGE’ transmitted from the transmission IP terminal 10, outputs the extracted result to a display unit (not shown) for viewing by a user and transmits a ‘200 OK’ message for acknowledging the reception of the ‘MESSAGE’ to the transmission IP terminal 10 (S9).

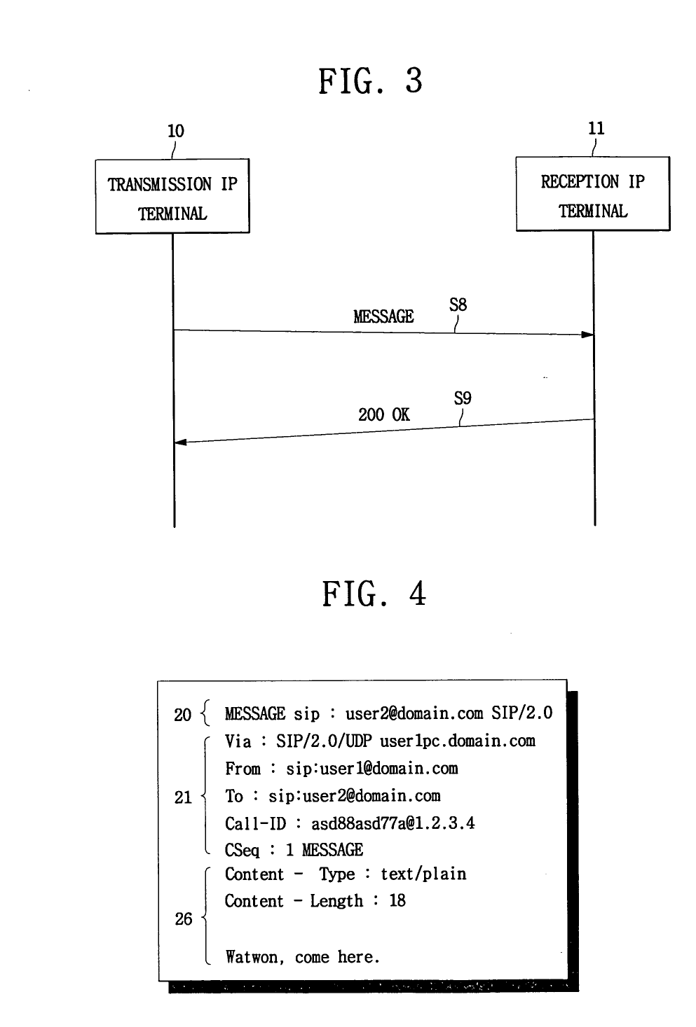

FIG. 4 is a structure of a ‘MESSAGE’ in a ‘MESSAGE’ method in an SIP scheme.

Referring to FIG. 4, the structure of the ‘MESSAGE’ in the ‘MESSAGE’ method consists of a start line 20, a general header 21 and character information 26.

The start line 20 indicates a start of the ‘MESSAGE.’

The general header 21 includes a request message and a response message, and represents a selected path for ‘Via,’ a respondent of request for ‘TO,’ an initiator of request for ‘From,’ invitation to a specific call or registration of a specific client for ‘Call-ID,’ and a priority of a corresponding message for ‘CSeq.’

The character information 26 contains information on transmission character messages, and represents a type of transmission character information for ‘Content-Type: text/plain’ a length of character information for ‘Content-Length: 18’ and a transmission character message for ‘Watson, come here.’

The reception IP terminal II which has received this ‘MESSAGE’ extracts and outputs the character information of ‘Watson, come here,’ and transmits an ‘200 OK’ acknowledgement message to the transmission IP terminal 10.

However, the Short Message Service is not provided while the call between the transmission and reception IP terminals 10 and 11 is set up to perform voice communication.

Additionally, if the IP terminal to which the call has been set up to perform the communication according to the ‘INVITE’ method of SIP receives a call set-up request from a third IP terminal, it is inconvenient for the IP terminal not to exchange any information with the third IP terminal making the call set-up request.

In other words, when the IP terminal in a busy state receives the voice communication request from the third IP terminal, it is impossible for the IP terminal to exchange any information with the third IP terminal. However, technology capable of overcoming the problem has not yet been realized.

Reference will now be made in detail to exemplary embodiments of the present invention, which are illustrated in the accompanying drawings.

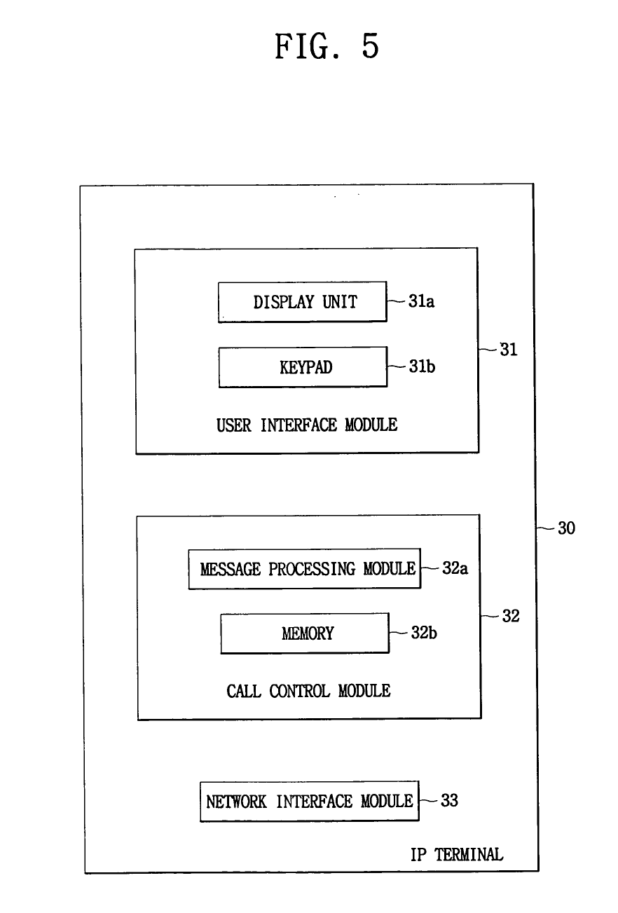

FIG. 5 is an internal block construction of an IP terminal employed with an embodiment of the present invention.

Referring to FIG. 5, an IP terminal 30 includes a user interface module 31, a call control module 32 and a network interface module 33.

The IP terminal 30 is capable of providing a Voice over Internet Protocol (VoIP), and can be exemplified by a gateway, a gatekeeper, a Multi Point Control Unit (MPCU), a server or so forth.

The user interface module 31 includes a display unit 31a and a keypad 31b, and the call control module 32 includes a message processing module 32a and a memory 32b.

The display unit 31a of the user interface module 31 outputs corresponding display information according to a display signal received from the call control module 32, thereby enabling a user to view the output result.

The display information can include at least one of display information according to a call set-up request signal received from another IP terminal, address information on the IP terminal 30 to which the call has been set up to perform voice communication, and display information informing that, when such a call set-up request signal is received from a third IP terminal while the call has been set up to perform voice communication, the call set-up request signal is received in a busy state.

The keypad 31b is provided with at least one key, and provides a signal corresponding to the key to the call control module 32 when the key is selected by a user.

The signal selected by the user with the key of the keypad 31b can include an address information signal of another IP terminal 30, a Short Message Service request signal, a character information signal, and so on.

The network interface module 33 performs interfacing so as to allow the IP terminal 30 to set up the call to another IP terminal through a network to perform voice communication.

In this manner, it is possible for the IP terminal 30 to set up the call to another IP terminal through the network to perform voice communication according to the VoIP. Even though a Session Initiation Protocol (SIP) is taken as one example, the call between the IP terminals can be set up to perform voice communication on the basis of another protocol without departing from the scope of the present invention.

The call control module 32 functions to set up the call to another IP terminal to perform the voice communication through the network interface module 33 according to the SIP.

In other words, when the call is set up to another IP terminal 30 provided with address information, which a user inputs via the keypad 31b, through the network interface module 33 according to an ‘INVITE’ method, and then when a call set-up request signal is received via the network interface module 33 according to the ‘INVITE’ method, the call control module 32 sets up the call between the IP terminals.

The memory 32b of the call control module 32 stores various information, that is, IP address, telephone number, e-mail address and so on, of a correspondent IP terminal to which the call has been set up to be in a busy state,.

Further, the memory 32b stores the various information, such as IP address, telephone number, e-mail address and so on, given to the IP terminal 30 so as to set up the call to another IP terminal through the network, and provides each stored information according to a request of the call control module 32.

When a user requests a preset message service via a message key of the keypad 32b, the message processing module 32a processes the message service which the user requests, and provides the processed result to the user.

The user of the IP terminal 30 can either press a certain key of the keypad 31b or press a combination of certain keys of the keypad 31b, the function of the keys being defined when the IP terminal 30 was designed or manufactured.

While the IP terminal 30 sets up the call to a correspondent IP terminal to perform voice communication through the network, the user of the IP terminal 30 selects the preset message key of the keypad 31b in order to transmit character information to the correspondent IP terminal. In this case, the message processing module 32a outputs a list of the address information of the correspondent IP terminal stored in the memory 32b to the display unit 31a of the user interface module 31.

When the character information is received from the user via the keypad 31b, a structure consisting of both the address information of the correspondent IP terminal and the inputted character information is stored in the memory 32b. The inputted character information is transmitted to the correspondent IP terminal via the network interface module 33 using the ‘MESSAGE’ method of the SIP.

In this case, the structure consisting of an address information field of the correspondent IP terminal and a field of the character information inputted by the user can be represented by Table 1.

TABLE 1

| IP address information of the | Transmission and reception character |
|---|---|
| correspondent IP terminal | information |
| 1234 | ABCDE |

It can be seen from Table 1 that the call is set up to the correspondent IP terminal provided with the address information of ‘1234,’ that the user inputs the character information of ‘ABCDE,’ and that the inputted character information is transmitted to the correspondent IP terminal provided with the address information of ‘1234.’

Meanwhile, when the call set-up request, i.e., the ‘INVITE,’ message is received from the third IP terminal while the call is set up to the correspondent IP terminal to perform voice communication, because the IP terminal 30 has set up the call to perform voice communication, the call control module 32 of the IP terminal 30 transmits a ‘busy here’ message to the third IP terminal that transmitted the call set-up request according to the SIP to inform the third IP terminal that the IP terminal 30 is in a busy state.

Further, the call control module 32 outputs both address information of the third IP terminal transmitting the call set-up request and a message of the call set-up request through the display unit 31a of the user interface module 31, and thus allows the user to be informed that a call set-up request signal has been received from the third IP terminal.

In this case, the call control module 32 makes it possible to output a structure comprising the address information field of the correspondent IP terminal which is in a busy state, the address information field of the third IP terminal and the field inputted the character information from the user, to the display unit 31a of the user interface module 31, as represented by Table 2.

TABLE 2

| address information of the | Transmission and reception character |
|---|---|
| correspondent IP terminal | information |
| 1234 | ABCDE |
| 5678 | ‘busy call’ |

It can be seen from Table 2 that the user is informed that the IP terminal 30 performs the voice communication with to the correspondent IP terminal provided with the address information of ‘1234’ at present, and that the call set-up request is received from the third IP terminal having the address information of ‘5678.’

The ‘busy call’ is the character information informing the user that the call set-up request has been received from the third IP terminal in a busy state. The character information indicating that the call set-up request has been received from the third IP terminal in a busy state is optionally set by the user through the keypad 31b in order to increase convenience of the user, and is stored in and outputted from the memory 32b.

Preferably, then, the message processing module 32a causes both the address information of the correspondent IP terminal to which the call is set up to perform voice communication at present and the address information of the third IP terminal which requests the call set-up in the busy state to be automatically stored in the memory 32b, and causes the address information, stored in the memory 32b, of both the correspondent IP terminal which is in a busy state and the third terminal which requests the call set-up to be displayed on the display unit 31a when the user selects the preset message key of the keypad 31b, so that the user can select the address information with ease.

In other words, the message processing module 32a outputs the structure as in Table 2 through the display unit 31a, receives the character information from the user when the user selects the preset message key in order to use the message service, and then automatically stores the received result in the memory 32b.

Further, the message processing module 32a transmits the character information, which is inputted into the IP terminal 30 having the IP address selected by the user, to the network interface module 33 using the ‘MESSAGE’ method.

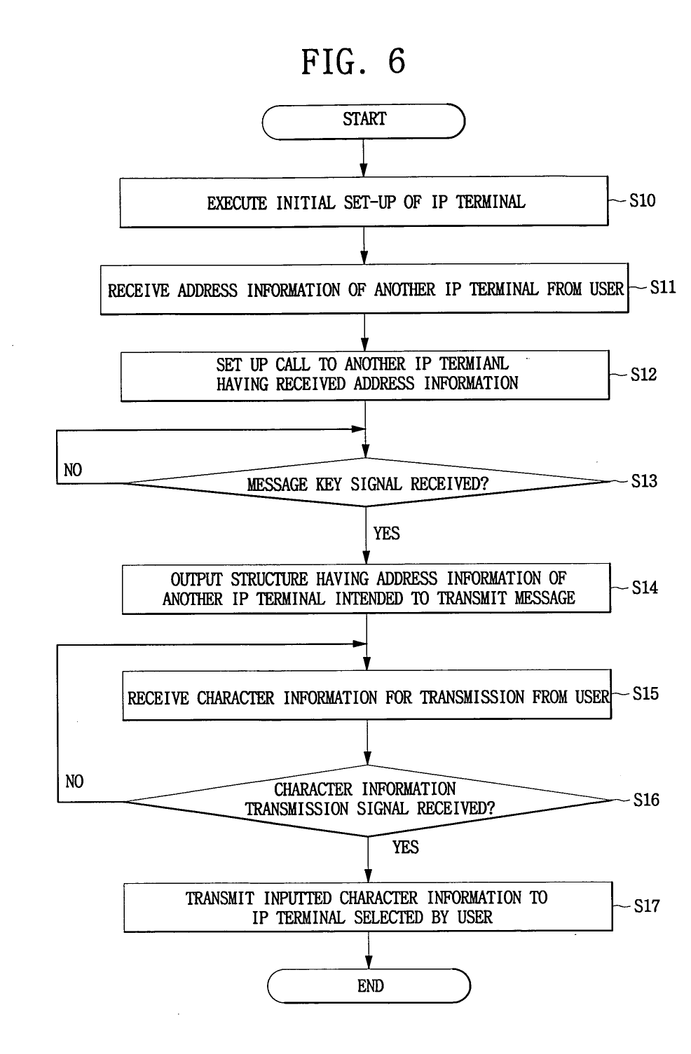

FIG. 6 is a flowchart explaining a method of transmitting character information to a correspondent IP terminal in a busy state in accordance with an embodiment of the present invention.

Referring to FIGS. 5 and 6, first, a user executes an initial set-up so that his/her own IP terminal 30 sets up a call to another IP terminal through the network to perform voice communication (S10).

The initial set-up refers to setting up IP address information, telephone number information, e-mail address information, message service ON/OFF information, relevant server IP address information, and so forth, all of which are given to the IP terminal 30 of the user.

The message service ON/OFF information represents whether or not the user makes use of the message service through the IP terminal 30. Hereinafter, a description follows for the case in which the user makes use of the message service through the IP terminal 30.

After the initial set-up is completed, the IP terminal 30 receives address information of another IP terminal, which is intended to set up the call through the keypad 31b, from the user (S11).

The call control module 32 of the IP terminal 30 sets up the call to an arbitrary IP terminal corresponding to the address information inputted by the user through the network interface module 33 using the ‘INVITE’ method (S12).

In other words, a determination is made as to whether an ‘INVITE’ message has been transmitted to another IP terminal according to the ‘INVITE’ method of the SIP, and whether an ‘200 OK’ message has been received from the another IP terminal to which the ‘INVITE’ has been transmitted.

If the ‘200 OK’ message has been received from the another IP terminal, an ‘ACK’ message is finally transmitted to the another IP terminal, thereby setting up a call.

Thus, voice communication is performed with the another IP terminal to which the call has been set up.

The call control module 32 of the IP terminal 30 stores address information of the another IP terminal in the memory 32b.

Then, while the voice communication is performed by the call set-up to the another IP terminal, the call control module 32 determines whether the preset message key of the keypad 31b has been selected by the user (S13).

If so, the message processing module 32a outputs a list of the address information of the another IP terminal which has been stored in the memory 32b through the display unit 31a of the user interface module 31 (S14).

In other words, the message processing module 32a outputs a structure having fields of both the address information of the another IP terminal and character information inputted from the user as in Table 1 through the display unit 31a of the user interface module 31, and is on standby until character information is inputted from the user.

When the user checks the structure outputted through the display unit 31a to input the character information into the field of the character information via the keypad 31b, the message processing module 32a stores the structure, into which the character information has been inputted, in the memory 32b (S15).

Then, a determination is made as to whether the user has selected a preset character send key, i.e., whether a character transmission signal has been received (S16).

The character send key can be set up in a manner that the user arbitrarily combines at least one special character or key. For instance, a description follows of the case of setting up a ‘*’ key to the character send key.

When the user selects the ‘*’ key of the keypad 31b and a character transmission request signal is received from the keypad 31b, the message processing module 32a transmits the character information, which is inputted into the another IP terminal having the address information stored as the structure in the memory 32b, through the network interface module 33 using the ‘MESSAGE’ method of the SIP (S17).

Meanwhile, the IP terminal 30 receiving the character information through the ‘MESSAGE’ method of the SIP allows the structure received through the display unit 31a, i.e., the character information, and address information of the correspondent IP terminal transmitting the character information, to be outputted and recognized by the user.

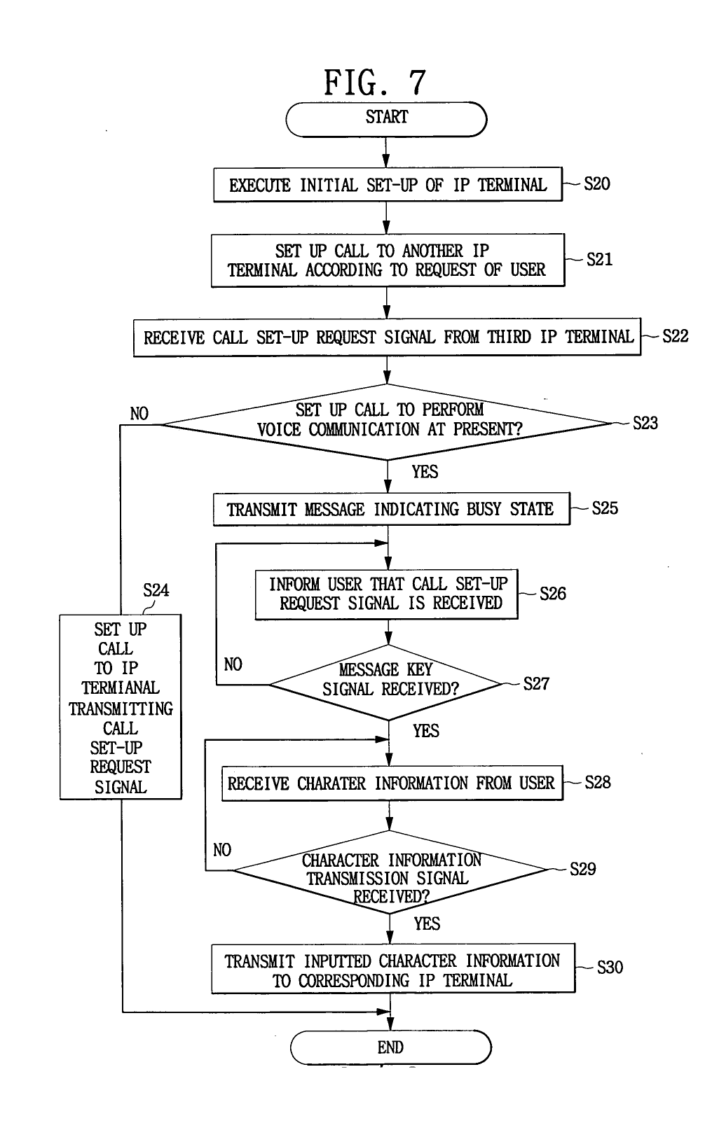

FIG. 7 is a flowchart explaining a method of transmitting character information to a third IP terminal in a busy state in accordance with another embodiment of the present invention.

As shown in FIG. 7, first, the user executes an initial set-up so that his/her own IP terminal 30 sets up a call to another IP terminal through the network to perform voice communication, that is, the user sets up IP address information, telephone number information, e-mail address information, message service ON/OFF information, relevant server IP address information and so forth, all of which are given to the IP terminal 30 of the user (S20).

After the initial set-up has been completed, the call control module 32 of the IP terminal 30 transmits a call set-up request signal to the another IP terminal via the network according to the ‘INVITE’ method of the SIP, and then sets up the call to the another IP terminal (S21).

In other words, a determination is made as to whether an ‘INVITE’ message has been transmitted to another IP terminal according to the ‘INVITE’ method of the SIP, and a ‘200 OK’ message has been received from the another IP terminal to which the ‘INVITE’ has been transmitted.

If the ‘200 OK’ message has been received from the another IP terminal, an ‘ACK’ message is finally transmitted to the another IP terminal, thereby setting up a call.

Thus, voice communication is performed with the another IP terminal to which the call has been set up.

The call control module 32 of the IP terminal 30 stores address information of the another IP terminal, to which the call has been set up through the network, in the memory 32b.

Then, while the call has been set up to the another IP terminal to perform voice communication, the call control module 32 receives the call set-up request signal from the third IP terminal (S22).

In other words, the call control module 32 receives the ‘INVITE’ message through the network interface module 33 from the third IP terminal other than the another IP terminal to which the call has been set up through the network to perform voice communication.

The call control module 32 receiving the ‘INVITE’ message determines whether the call is set up to the another IP terminal through the network to perform voice communication (S23).

If the call has been disconnected with the another IP terminal so as to be in an idle state, the call control module 32 sets up the call to the third IP terminal transmitting the ‘INVITE’ message through the network (S24).

Meanwhile, if the call has been set up to the another IP terminal to perform voice communication, the call control module 32 transmits a ‘busy here’ message informing the user that the call has already been set up to perform voice communication to the third IP terminal transmitting the ‘INVITE’ message (S25).

The message processing module 32a adds an address information field of the third IP terminal 30 which has transmitted the ‘INVITE’ message, to the structure as in Table 1 having an address information field of the another IP terminal to which the call is set up at present, updates the structure as in Table 2, and then causes the updated structure to be outputted through the display unit 31a for the user to view the outputted result (S26).

The structure, which is outputted through the display unit 31a of the user interface module 31 as set forth in Table 2, allows the user to see that a call set-up request signal has been received from the third IP terminal in a busy state by inserting and outputting ‘busy call’ character information into a character information field corresponding to the address information field of the third IP terminal 30 which has transmitted the ‘INVITE’ message while the call has been set up to perform voice communication. The updated structure is stored in the memory 32b.

The message processing module 32a outputs the structure added by the address information field of the third IP terminal 30 transmitting the ‘INVITE’ message through the display unit 31a of the user interface module 31, and determines whether the user has selected the preset message key of the keypad 31b and thus a message key signal is received from the keypad 31b (S27).

If so, the message processing module 32a receives the character information, which is intended to be transmitted to the third IP terminal 30 transmitting the ‘INVITE’ message from the user, through the character information field (S28).

In this case, the user can select the another IP terminal to which the call is set up to perform the communication or the third IP terminal transmitting the call set-up request signal from the structure outputted through the display unit 31a.

Preferably, the message processing module 32a outputs the structure through the display unit 31a of the user interface module 31 to allow the user to automatically select the address information of the third IP terminal with ease.

Further, the message processing module 32a automatically stores the structure, into which the character information intended for transmission is inputted, in the memory 32b.

The message processing module 32a determines whether the user has inputted the character information intended for transmission and has selected the character send key of the keypad 31b and thus a character transmission request signal has been received from the keypad 31b (S29).

In other words, the message processing module 32a determines whether the user finishes inputting the character information to select a ‘*’ key of the keypad 31b and thus the character transmission request signal has been received.

If the character transmission request signal has been received, the message processing module 32a transmits the character information received through the character information field of the structure to the third IP terminal through the network interface module 33 according to the ‘MESSAGE’ method of the SIP (S30).

Meanwhile, the IP terminal 30 receiving the character information through the ‘MESSAGE’ method of the SIP allows the structure received through the display unit 31a, i.e., the character information, and address information of the correspondent IP terminal 30 transmitting the character information, to be outputted and recognized by the user.

By contrast, if the user selects the message key of the keypad 31b in a state where the call is set up to the another IP terminal according to the ‘INVITE’ method of the SIP and the message key signal is thereby received from the keypad 31b, that is to say, if the user selects the message key of the keypad 31b in order to transmit the character information to the third IP terminal in a state where the user makes use of his/her own IP terminal 30 to perform voice communication with the another IP terminal, the message processing module 32a outputs the structure as in Table 2 through the display unit 31a.

The message processing module 32a receives both the address information of the third IP terminal intended to transmit the character information as well as the character information intended for transmission from the user through the structure outputted through the display unit 31a.

The message processing module 32a can directly receive the address information of the third IP terminal from the user through the structure, or can output a list of the address information of the IP terminal 30 which is automatically stored in the memory 32b through the display unit 31a to be selected by the user from among from the outputted address information of the IP terminal 30.

Further, the message processing module 32a determines whether or not the character transmission request signal has been received. If so, the message processing module 32a transmits the character information inputted into the third IP terminal, which has received the address information from the user in the state of maintaining the call set-up to the another IP terminal using the ‘MESSAGE’ method of the SIP.

Meanwhile, the third IP terminal receiving the character information through the ‘MESSAGE’ method of the SIP allows the address information of the IP terminal transmitting the character information and the received address information to be outputted through the display unit 31a and recognized by the user.

As can seen from the foregoing, although exemplary embodiments of the present invention have been described only with respect to the IP terminal capable of exchanging short messages in a busy state and the method for doing so, particularly, on the transmission side, those skilled in the art will appreciate that various modifications, additions and substitutions are possible, without departing from the scope and spirit of the invention as recited in the accompanying claims.

According to the present invention, a user using an IP terminal to which a call has been set up according to a VoIP to be in a busy state exchanges character information with the correspondent using another IP terminal to which the call is set up through a network to perform voice communication, so that the character information can be safely exchanged even though it is difficult to transmit voice information.

Further, even when a call set-up request is received from a third IP terminal while the call is set up through the network to be in a busy state, the IP terminal can exchange information with the third IP terminal requesting the call set-up while continuing to perform voice communication.

1. An Internet Protocol terminal comprising:
a memory adapted to store address information of another Internet Protocol terminal to which a call is set up and character information intended to be transmitted to the another Internet Protocol terminal; and
a message processor adapted to generate and display both an address information field of the another Internet Protocol terminal stored in the memory and a character information input field upon the call being set up to the another Internet Protocol terminal and upon a Short Message Service request signal being received from a user; and
the message processor adapted to store the inputted character information in the memory and to transmit the stored character information to the another Internet Protocol terminal upon the character information intended for transmission being inputted via the character information input field.

2. The Internet Protocol terminal according to claim 1, wherein the message processor comprises:
a character information processor adapted to generate and output the character information input field, and to receive and store the character information from the user inputted via the character information input field; and
a transmitter adapted to determine whether or not a character information transmission request signal has been received from the user, and if so, to transmit the character information to the another Internet Protocol terminal, the character information being received from the character information processor and stored.

3. The Internet Protocol terminal according to claim 2, wherein the character information processor is adapted to generate and display the character information input field to correspond to a display field outputting the address information of the another Internet Protocol terminal.

4. An Internet Protocol terminal comprising:
a memory adapted to store address information of respective Internet Protocol terminals and character information intended for transmission; and
a message processor adapted to store address information of a third Internet Protocol terminal in the memory upon a call being set up between a first Internet Protocol terminal and a second Internet Protocol terminal in a Voice over Internet Protocol mode and upon a call set-up request signal being received from the third Internet Protocol terminal; and
the message processor being adapted to generate and display both input fields for the stored address information of the respective Internet Protocol terminals and character information input fields and to store the character information inputted via the character information input fields upon a Short Message Service request signal being received from a user; and
the message processor being adapted to transmit the inputted character information to the third Internet Protocol terminal upon a character information transmission request signal being received from the user upon the call being set up between the first Internet Protocol terminal and the second Internet Protocol terminal.

5. The Internet Protocol terminal according to claim 4, wherein the message processor is adapted to generate and display the character information input fields and the address information input fields upon the Short Message Service request signal being received from the user and upon the call being set up to the second Internet Protocol terminal; and
wherein the message processor is adapted to transmit the character information inputted via the character information input fields to the third Internet Protocol terminal inputted via the address information input fields from the user.

6. The Internet Protocol terminal according to claim 4, wherein the message processor comprises:
a voice communication processor adapted to transmit a busy message to the third Internet Protocol terminal and to store the address information of the third Internet Protocol terminal in the memory upon the call set-up request signal being received from the third Internet Protocol terminal; and
a character information processor adapted to generate the character information input fields and to add the character information indicating that the call set-up request signal has been received from the third Internet Protocol terminal in a busy state in response to the generated character information input fields and to display the added character information.

7. The Internet Protocol terminal according to claim 6, wherein the character information processor is adapted to generate and display the character information input fields to correspond to the address information of the first, second and third Internet Protocol terminals and to automatically select the third Internet Protocol terminal as the Internet Protocol terminal for transmitting the character information upon the Short Message Service request signal being received from the user.

8. The Internet Protocol terminal according to claim 7, wherein the Internet Protocol terminal for transmitting the character information is adapted to automatically select the third Internet Protocol terminal transmitting the call set-up request signal upon the call being set up and upon the Short Message Service request signal being received from the user and to select the Internet Protocol terminal selected by the user upon an Internet Protocol terminal select signal being received from the user.

9. A method comprising:
setting up a call to another Internet Protocol terminal through a network according to a call set-up method of the Voice over Internet Protocol and storing address information of the another Internet Protocol terminal to which the call is being set up;
generating and outputting both a field for the stored address information and a character information input field upon a Short Message Service request signal being received from a user;
receiving and storing character information intended for transmission from the user via the character information input field and determining whether or not a character information transmission signal has been received; and
transmitting the character information inputted via the character information input field to the another Internet Protocol terminal upon a determination that the character information transmission signal has been received.

10. A method comprising:
setting up a call between first and second Internet Protocol terminals via a network according to a call set-up method of the Voice over Internet Protocol and storing address information of the second Internet Protocol terminal to which the call is being set up;
transmitting a busy message to a third Internet Protocol terminal upon the call being set up to the second Internet Protocol terminal and upon a call set-up request signal being received from the third Internet Protocol terminal;
storing address information of the third Internet Protocol terminal and generating and displaying both a field for the address information of the third Internet Protocol terminal and a character information input field;
receiving and storing character information intended for transmission from the user via the character information input field and determining whether or not a character information transmission signal has been received; and
transmitting the character information inputted via the character information input field to the third Internet Protocol terminal upon the call being set up between the first and second Internet Protocol terminals and upon a determination that the character information transmission signal has been received.

11. The method according to claim 10, further comprising:
automatically selecting the address information of the third Internet Protocol terminal transmitting the call set-up request signal upon the call being set up as address information of the Internet Protocol terminal for transmitting the character information; and
selecting address information of the selected Internet Protocol terminal as the address information of the Internet Protocol terminal for transmitting the character information upon an Internet Protocol terminal select signal being received from the user.

12. The method according to claim 10, wherein the character information input field has added information and is used to generate character information from which the user can determine that the call set-up request signal has been received in a busy state.

13. A method comprising:
setting up a call to an arbitrary terminal through a network according to a call set-up method of the Voice over Internet Protocol and to store address information of the terminal to which the call is being set up;
displaying a display signal corresponding to the stored address information of the terminal and a request signal requesting that character information intended for transmission be inputted via the terminal upon a Short Message Service request signal being received;
storing the inputted character information and determining whether or not a character information transmission signal has been received upon the character information intended for transmission being inputted from the terminal in response to the request signal; and
transmitting the stored character information to the terminal to which the call is being set up upon a determination that the character information transmission signal has been received.

14. A method comprising:
storing address information of a second terminal to which a call is being set up in a first terminal upon a call being set up between the first and second terminals via a network according to a call set-up method of the Voice over Internet Protocol;
transmitting a message to a third terminal indicating that the call is being set up upon the call being set up to the second terminal and upon a call set-up request signal being received from the third terminal;
displaying a display signal of address information of the third terminal and a request signal requesting that character information intended for transmission is being inputted via one of the first and second terminals upon a Short Message Service request signal being received;
storing the inputted character information and determining whether or not a character information transmission signal has been received upon the character information being inputted from one of the first and second terminals in response to the request signal; and
transmitting the stored character information to the third terminal upon the call being set up between the first and second terminals upon a determination that the character information transmission signal has been received.

15. The method according to claim 14, further comprising:
automatically selecting the address information of the third terminal transmitting the call set-up request signal upon the call being set up as the address information of the terminal for transmitting the character information received in response to the request signal upon the Short Message Service request signal being received; and
selecting the received address information upon arbitrary address information being received while the character information is being inputted.
